(19) United States
(12) Patent Application Publication
(10) Pub. No.: US 2005/0102307 A1
(43) Pub. Date: May 12, 2005

(54) Online interactive identification

(76) Inventors: Lamson Donette, Carlsbad, CA (US); Ronald E Faulk, Glendale, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 10/399,821

(22) PCT Filed: Nov. 20, 2001
(86) PCT No.: PCT/US01/43707

Related U.S. Application Data
(60) Provisional application No. 60/252,190, filed on Nov. 20, 2000.

(51) Int. Cl. G06F 17/00

(52) U.S. Cl. 707/102

(57) ABSTRACT

The present invention provides systems and methods in which a software module incorporates in online identification. The software may be further programmed to use diagnostic rules and to link to a web sites to provide additional information and to engage in e-commerce.

This application claims the benefit of U.S. provisional application No. 60/252190 filed on Nov. 20, 2000 and Ser. No. 60/252539 filed on Nov. 22, 2000, both incorporated herein by reference in their entirety.

### FIELD OF THE INVENTION

The field of the invention is online interactive identification.

### BACKGROUND OF THE INVENTION

Online interactive systems and methods of identification that attempt to aid in the identification of a subject such as a disease, a plant, or an insect generally require an abundant amount of descriptive input. In some systems a user is asked to type, speak, or otherwise select descriptive information about the subject to be identified. Other systems require photographs that are input into systems using a cable connected to a digital camera. Perhaps photos need to be converted to a certain format before the system can use them. Many identification systems follow a tree structure in which a querying party is asked a series of questions designed to either exclude or include non-matching or matching entries, respectively. Often such interactions require significant amounts of time interpreting and responding to the series of questions. In any case, getting data into an online identification system is often quite burdensome, and may lead to inaccurate and inconsistent identifications due to many factors such as tree logic, interpretation of questions, completeness and accuracy of answers, mistakes and inconsistencies in answers, and even biases.

To circumvent at least some of the problems associated with entry of data, U.S. Pat. No. 4,029,418 to Cottingham et al. (June 1977) teaches an optical comparator that compares a photograph with an optical scan. While an optical comparator may reduce the time spent to enter data and increase the accuracy and consistency of such entry, the feasibility of using the necessary equipment is impacted by the cost, size, and complexity of the equipment. For many applications, an optical comparator is not feasible. U.S. Pat. No. 6,014,451 to Berry et al. (January 2000) teaches systems and methods for diagnosing plant diseases at a remote site by using remote video imaging. Although some of the problems associated with capturing an image at a remote location are addressed by the '451 patent, problems related to lighting, equipment size, and cost still may be prohibitive.

Another way in which the burden of entering input has been reduced is by incorporating user profiles into searches. Such profiles include user dependent information that changes depending on which user is making the query. U.S. Pat. No. 6,266,668 to Vanderveldt et al. (July 2001) involves using user dependent profile information in a data-mining search engine. The search engine would take into account demographic and historical user information to narrow the number of web sites that match a query. U.S. Pat. No. 6,292,796 to Drucker et al. (September 2001) also incorporates user dependent information into an identification process. The '796 patent teaches that user profile information may aid in the identification of literature that is of interest to the querying party. For example, a doctor can obtain information relevant to the care of a particular patient by using the particular patient's profile information to search for literature. Because user profile information is entered only once, subsequent queries typically require less manual input and provide less opportunity for mistakes. Another way in which patient profile information is used in the medical field is described in U.S. Pat. No. 6,317,719 to Schrier et al. (November 2001). The '719 patent teaches systems and methods in which patient information profile information is used to determine a dosage of a drug. Although user dependent profile information may prove important in certain fields, there are many fields in which profile information has little or no importance on identification (e.g. plant identification, pest identification, plant disease diagnosis).

There is a need for methods and devices that increase the effectiveness and reduce the burden of doing an online identification.

### SUMMARY OF THE INVENTION

The present invention provides systems and methods in which a software module incorporates user independent information to aid in online identification. The software may be further programmed to use variables and diagnostic rules to obtain results. A link to a web site may provide additional information and allow engagement in e-commerce.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a schematic of a system of online identification.

FIG. 2 is a schematic of a system in which information is passed to suppliers.

FIG. 3 is a block diagram of a method of obtaining information.

### DETAILED DESCRIPTION

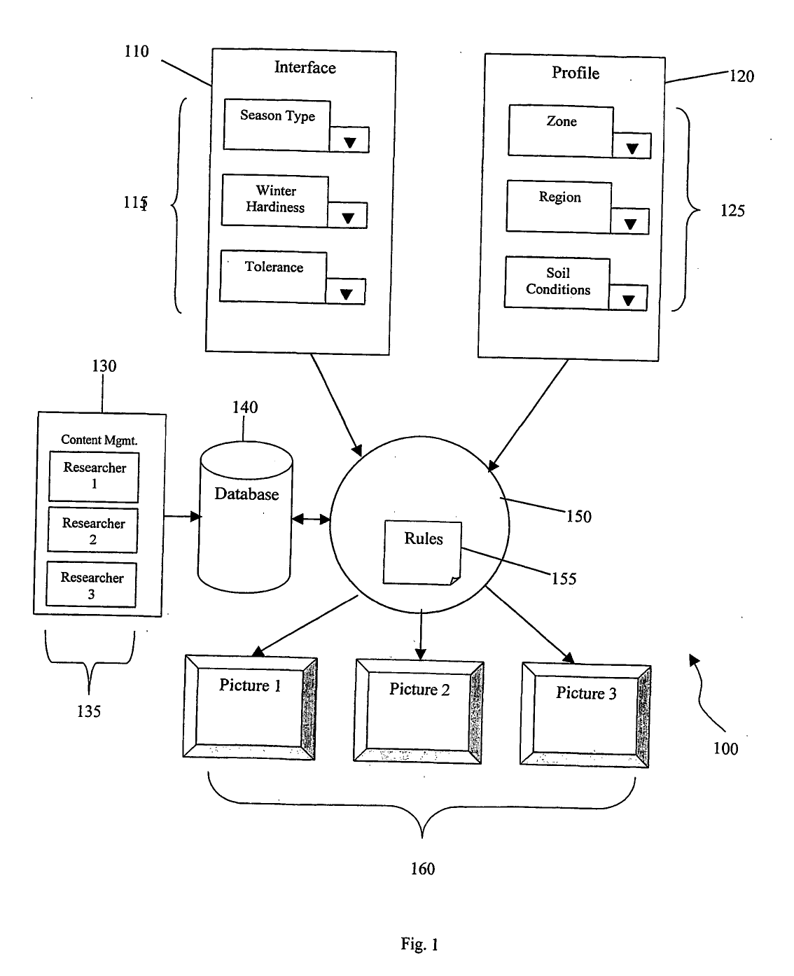

Referring first to FIG. 1, a system of online identification 100 generally comprises an interface 110, a user-independent profile 120, a content management system 130, a database 140, a software module 150, and results 160.

An interface 110 is any combination of software and hardware that may be used to collect data. A preferred interface 110 displays 20 search fields. More preferably, the interface displays 30 search fields, and even more preferably 40 search fields. It is contemplated that an interface 110 may be operational on a wide variety of devices including a desk top computer, a lap top computer, a PDA, a cellular phone, a pager, and so on.

A preferred interface 110 is comprised of search fields 115 that are generally interrelated to some degree. For example, if a subject to be identified is a grass, exemplary search fields may be water usage, winter hardiness, mowing quality range, and tolerance. If a subject to be identified is a car, exemplary search fields may relate to make, model, engine size, number of doors, etc.

Selection of search field contents (not shown) may include activating a drop down menu and making a choice by clicking on the most appropriate contents. Contents related to “Season Type” may, for instance, include the possibilities of “Cool” and “Warm”. If “Cool” were selected, a variable corresponding to “season type—cool” would be used by the system to obtain results. Thus a preferable variable comprises contents' (e.g. “cool”) and field name (e.g. “season type”).

A profile 120 comprises user independent information 125 that is used by a software module 150 to obtain results 160. As used herein, “user independent information” is relatively constant information that is substantially unrelated to a particular user. A test for whether an item of information is user independent information may be to ask whether the information is affected by the life of the user. Implementing this test, income, interests, and marital status are not user independent information, but annual rainfall, zone (i.e. geographical) and soil conditions (e.g. sandy) are user independent information. User independent information 125 is preferably relatively constant, and therefore may be entered only once. The user independent information 125 is preferably saved and used in subsequent searches without the need for reentry.

A software module 150 uses at least one variable that has been selected using the interface 110. The software module 150 also uses at least one item of user independent information 125 that has been entered in the profile screen 120. The software module 150 may also incorporate rules 155 that advantageously control the results 160 that are obtained.

In a preferred class of embodiments, a software module 150 accesses a data store, which generally comprises at least one database 140. A preferred data store comprises information that will be used by the software module 150 to obtain results, and as such, the information on the database 140 generally relates to the subject of identification.

It is further contemplated that a software module 150 may use rules 155 to aid in identification. Rules 155 are instructions that define, constrain, control, or influence the behavior of the identification structure. Rules 155 may vary depending on the entity using the system or even upon the type of subjects being identified. Rules 155 preferably add structure to the identification process and aid in the accuracy of an identication.

Additional input to a database 140 may be provided by a plurality of independent researchers 135 working as part of a content management team 130. It is contemplated that independent researchers 135 are entities other than the entity that provides access to the system (i.e. the web host or server). Preferred independent researchers are entities that add value to the data on the database 140. For example, an independent researcher may be a university professor or lab team that is conducting research in a field that relates to the subject of the identification. As used herein, “maintain” as in “an information store maintained by a plurality of independent researchers” means make additions, and deletions to the data.

Results 160 are generally a representation of the record or records that have been selected by the software module 150. Selection of records may involve instructions that include records that match or exclude records that don't match. The matching criteria are preferably a plurality of variables and a plurality of user independent information. In any case, a software module 150 is programmed to obtain results that aid in identification and/or diagnosis.

Results 160 may be displayed in any appropriate format including a table format to facilitate comparison. Results are preferably displayed as pictures with text, and may also contain graphics. It is contemplated that clicking on a picture may provide additional information (through a link to a proprietary or third party web page) and/or a magnified view of the result for comparison purposes.

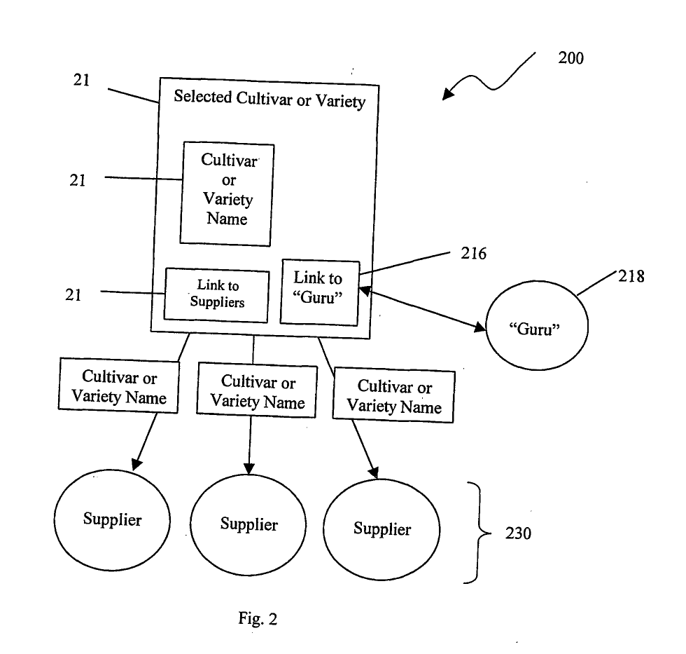

Referring to FIG. 2, a system 200 in which information is passed to a supplier 230 includes a display 210, a purchase related parameter 212, and a link to a supplier 214.

A display 210 may be any of the display screens and associated software of an online identification system or method. A user (not shown), may click on or otherwise activate a link 214 to a supplier 230 in order to purchase a product (not shown) or to just obtain additional information (not shown). Additional information may be obtained from a fact sheet database. A fact sheet database preferably comprises factual information that has been provided by universities. Alternatively and additionally, a research database may be accessed in order to provide research related information.

The link 214 preferably comprises a URL (uniform resource locator) that may be used to display a web page (e.g. an HTML document). It is contemplated that the link 214 will pass a purchase related parameter 212, which will be used by a web site to generate an order for a good or service. A purchase related parameter 212 may be embedded in a URL or may be passed separately, but in any case, the purchase related parameter 212 generally provides information that is related to the purchase. Exemplary purchase related parameters 212 may include product information (e.g. a grass cultivar, a fungicide), purchaser information (i.e. purchaser's name, address, and credit card information) and transferor information (e.g. the address of the web site that passed the link). It is further contemplated that such information may be used to calculate compensation to the transferor web site. If a link 214 is used simply to obtain additional information, the link may comprise a field of interest, a type of plant, or a disease name, for example.

A link 214 may comprise an e-mail notification that passes information via a standard e-mail protocol (e.g. STMP). It is contemplated an e-mail link may have at least one attachment of purchase related information.

Another contemplated link includes a link to a “guru” 214 in which a user is able to communicate by e-mail with a “guru” (e.g. a knowledgeable individual in the field). Communication between a guru and a user may also be accomplished by using streaming video, and voice on the net (e.g. Internet phone).

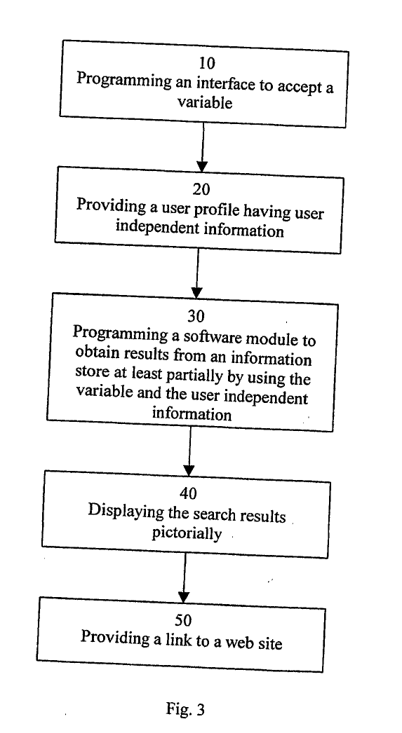

In FIG. 3 a method of obtaining information includes: 10 programming an interface to accept a variable; 20 providing a user profile having user independent information; 30 programming a software module to obtain results from an information store at least partially by using the variable and the user independent information, the software module may use rules that have hardcoded into the software module; 40 displaying the search results pictorially; and 50 providing a link to a web site—to obtain additional information or engage in e-commerce.

Thus, specific embodiments and applications of systems and methods of online interactive identification have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present; or utilized, or combined with other elements, components, or steps that are not expressly referenced.

1. A system comprising:
an interface programmed to accept a variable;
a profile having user independent information; and
a software module programmed to use the variable and the user independent information to obtain results.

2. The system of claim 1, wherein the variable comprises plant related information.

3. The system of claim 1, wherein the software module is further programmed to use diagnostic rules to obtain results.

4. The system of claim 1, wherein the variable comprises pest related information.

5. The system of claim 1, wherein the user independent information comprises at least one of a region, a zone, and a soil type.

6. The system of claim 1, wherein the results are displayed pictorially.

7. The system of claim 1, wherein the search results are displayed in an array.

8. The system of claim 1, further comprising an information store maintained by a plurality of independent researchers.

9. The system of claim 1, further comprising a third party web site that provides additional information.

10. The system of claim 1, further comprising at least one purchase related parameter passed to a vendor web site.

11. The system of claim 1, wherein the software is further programmed to run on a third party web site.

12. A method of obtaining information comprising:
programming an interface to accept a variable;
providing a user profile having user independent information; and
programming a software module to obtain results from an information store at least partially by using the variable and the user independent information.

13. The method of claim 12, wherein programming the interface further comprises displaying a menu for selection of the variable.

14. The method of claim 12, further comprising the step of querying via at least one of text, graphics, and pictures.

15. The method of claim 12, further comprising the step of overriding the user independent information.

16. The method of claim 12, further comprising the step of displaying the search results pictorially.

17. The method of claim 12, further comprising the step of displaying the search results in an array.

18. The method of claim 12, further comprising a plurality of independent researchers maintaining the information store.

19. The method of claim 12, further comprising the step of providing a link to at least one of a vendor web site and an informational web site.

20. The method of claim 19, further comprising the step of passing a purchase related parameter to the vendor web site.
